(19) United States
(12) Patent Application Publication
(10) Pub. No.: US 2019/0296399 A1
(43) Pub. Date: Sep. 26, 2019

(54) SECONDARY BATTERY

(71) Applicant: Murata Manufacturing Co., Ltd., Nagaokakyo-shi (JP)

(72) Inventors: Toru Kawai, Nagaokakyo-shi (JP); Masahiro Otsuka, Nagaokakyo-shi (JP)

(21) Appl. No.: 16/416,520

(22) Filed: May 20, 2019

Related U.S. Application Data
(63) Continuation of application No. PCT/JP2017/044084, filed on Dec. 7, 2017.

(30) Foreign Application Priority Data
Jan. 13, 2017 (JP) 2017-004476

(51) Int. Cl. H01M 10/0585; H01M 10/0587; H01M 10/0525

(52) U.S. Cl. CPC H01M 10/0585; H01M 10/0525; H01M 10/0587

(57) ABSTRACT

A secondary battery particularly suitable for installation in combination with a substrate is provided. The secondary battery of the present invention includes an electrode assembly in which electrode constituent layers including a positive electrode, a negative electrode, and a separator are laminated, and an exterior body enclosing the electrode assembly. In the secondary battery of the present invention, the electrode assembly has an assembly step configured with an assembly low surface at a relatively low level and an assembly high surface at a relatively high level, and the secondary battery has a battery step configured with a battery low surface at a relatively low level and a battery high surface at a relatively high level, and the battery low surface is a substrate placement surface with a margin of a position misalignment between the assembly step and the battery step.

### CROSS REFERENCE TO RELATED APPLICATIONS

The present application is a continuation of International application No. PCT/JP2017/044084, filed Dec. 7, 2017, which claims priority to Japanese Patent Application No. 2017-004476, filed Jan. 13, 2017, the entire contents of each of which are incorporated herein by reference.

### FIELD OF THE INVENTION

The present invention relates to a secondary battery. In particular, the present invention relates to a secondary battery configured with an electrode assembly formed by laminating electrode constituent layers wrapped with an exterior body.

### BACKGROUND OF THE INVENTION

The secondary battery includes at least a positive electrode, a negative electrode, and a separator between them. The positive electrode is configured with a positive electrode material layer and a positive electrode current collector, and the negative electrode is configured with a negative electrode material layer and a negative electrode current collector. The secondary battery has a laminate structure in which an electrode constituent layer including the positive electrode and the negative electrode sandwiching the separator are laminated on top of each other, and an electrode assembly of such a laminate structure is enclosed in an exterior body together with an electrolyte.

Such a secondary battery is what is called a “storage battery” which can be repeatedly charged and discharged, and is used for various purposes. For example, secondary batteries are used for mobile devices, such as a mobile phone, a smart phone, and a notebook computer.

In various applications, including mobile devices and the like, a secondary battery is generally housed in a housing and used. That is, a secondary battery is disposed so as to partially occupy internal space of the housing.
Patent Document 1: Japanese Unexamined Patent Application Publication (Translation of PCT Application) No. 2015-536036

### SUMMARY OF THE INVENTION

The inventor of the present invention has noticed that there is a problem to be overcome in a conventional secondary battery, and found a necessity to take measures for that purpose. Specifically, the inventor of the present invention has found that there are problems described below.

It is necessary to consider the balance of installation space of the secondary battery with other equipment elements, such as a circuit board and various parts, in the housing. In particular, with diversification of needs in recent years, there is a tendency that installation space of a secondary battery tends to be more restricted by a housing and various elements housed in the housing. It has become difficult to deal sufficiently with such a tendency with a shape of a conventional secondary battery.

In particular, a secondary battery is often used together with a substrate (for example, an electronic circuit board typified by a printed circuit board and a protective circuit board) in a housing. For combined installation of such a substrate and a secondary battery, it is conceivable to make the shape of the secondary battery into an uneven shape from the viewpoint of effective utilization of the installation space. However, the inventor of the present invention has found that merely making it uneven is not always efficient for the installation in combination.

The present invention has been made in view of the above problem. That is, a main object of the present invention is to provide a secondary battery particularly suitable for installation in combination with a substrate.

The inventor of the present invention has tried to solve the above-mentioned problem by dealing in a new direction instead of dealing by following an extension of the prior art. As a result, the inventor has reached the invention of a secondary battery that achieves the above main object.

The secondary battery according to an aspect of the present invention includes an electrode assembly having laminated electrode constituent layers including a positive electrode, a negative electrode, and a separator between the positive electrode and the negative electrode; and an exterior body enclosing the electrode assembly. The electrode assembly has an assembly step connecting an assembly low surface and an assembly high surface at a higher level than the assembly low surface, the exterior body has a battery step connecting a battery low surface and a battery high surface at a higher level than the battery low surface, and there is a margin of a position misalignment between the assembly step and the battery step.

A secondary battery according to the present invention is particularly suitable for installing in combination with a substrate. More specifically, the secondary battery of the present invention having a battery low surface resulting from a step is more effectively usable as a substrate placement surface.

### BRIEF EXPLANATION OF THE DRAWINGS

FIGS. 1(A) and 1(B) are a cross-sectional views schematically showing an electrode constituent layer (where FIG. 1(A) is a non-wound portion, and FIG. 1(B) is a wound portion).

FIG. 2 is a perspective view, a cross-sectional view, and a plan view schematically showing features of a secondary battery (three-dimensional outer shape without a notch) according to one embodiment of the present invention.

FIG. 3 is a perspective view, a cross-sectional view, and a plan view schematically showing features of a secondary battery (three-dimensional outer shape with a notch) according to one embodiment of the present invention.

FIGS. 4(A) and 4(B) are schematic diagrams for explaining an effective area of a substrate placement surface resulting from a position misalignment between a step of an electrode assembly and a battery step as one embodiment of the present invention.

FIG. 5 is a schematic diagram for explaining a secondary battery including a notch portion in a three-dimensional outer shape as one embodiment of the present invention.

FIG. 6 is a schematic diagram for explaining “a dimensional relationship in which a position misalignment direction dimension of an assembly high surface is smaller than a difference between a maximum position misalignment direction dimension and a minimum position misalignment direction dimension in a contour shape of the electrode assembly” as one embodiment of the present invention.

FIGS. 7(A) to 7(C) are plan views schematically showing a process mode of a manufacturing method relating to a secondary battery according to one embodiment of the present invention.

FIG. 8 is a schematic diagram for explaining fabrication of an electrode assembly from a small piece shape and a large piece shape as one embodiment of the present invention

FIGS. 9(A) to 9(C) are plan views (conventional technique) schematically showing a process mode in a conventional manufacturing method.

### DESCRIPTION OF THE PREFERRED EMBODIMENTS OF THE INVENTION

Hereinafter, a secondary battery according to one embodiment of the present invention will be described in more detail. Description will be made with reference to the drawings as needed, and the various elements in the drawings are merely shown schematically and exemplarily for the understanding of the present invention, and the appearance, a dimensional ratio and the like may be different from the actual ones.

A “thickness” direction described directly or indirectly in the present description is based on a lamination direction of electrode materials constituting the secondary battery, that is, a “thickness” corresponds to a thickness in the lamination direction of a positive electrode and a negative electrode. A “planar view” used in the present description is based on a sketch of a case where an object is seen along a direction of the thickness.

A “vertical direction” and a “horizontal direction” used directly or indirectly in the present description respectively correspond to a vertical direction and a horizontal direction in the diagrams. Unless otherwise specified, the same reference numerals or symbols shall denote the same members or the same meanings and contents. In a preferred mode, it can be grasped that a downward direction in a vertical direction (that is, a direction in which gravity acts) corresponds to a “downward direction” and a direction opposite to the downward direction corresponds to an “upward direction”.

[Configuration of the Secondary Battery of the Present Invention]

In the present invention, the secondary battery is provided. The term “secondary battery” as used in the present description refers to a battery that can be repeatedly charged and discharged. Therefore, the secondary battery of the present invention is not excessively restricted to its name, and may include, for example, “power storage device”, and the like.

(Basic Configuration of Battery)

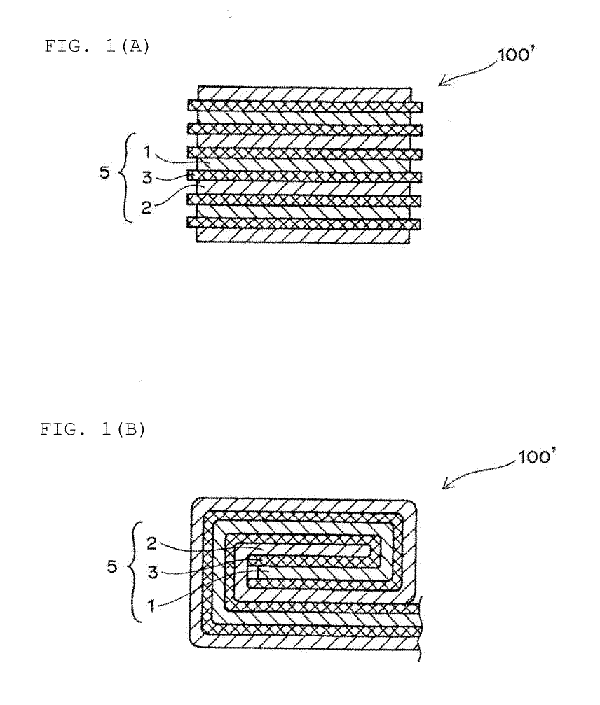

A secondary battery according to the present invention includes an electrode assembly in which electrode constituent layers including a positive electrode, a negative electrode, and a separator are laminated. An electrode assembly 100′ is illustrated in FIGS. 1(A) and 1(B). As shown in the drawing, a positive electrode 1 and a negative electrode 2 are laminated with a separator 3 interposed between them to form an electrode constituent layer 5, and at least one of the electrode constituent layer 5 is laminated so that the electrode assembly 100′ is configured. In FIG. 1(A), the electrode constituent layer 5 is laminated in a plane to have a planar laminate structure. On the other hand, in FIG. 1(B), the electrode constituent layer 5 is wound in a wound shape to have a wound laminate structure. In the secondary battery, the electrode assembly 100′ is enclosed in an exterior body together with an electrolyte (for example, a non-aqueous electrolyte).

The positive electrode is configured with at least a positive electrode material layer and a positive electrode current collector. In the positive electrode, a positive electrode material layer is provided on at least one side of the positive electrode current collector, and the positive electrode material layer contains a positive electrode active material as an electrode active material. For example, each of a plurality of the positive electrodes in the electrode assembly may include the positive electrode material layer provided on both sides of the positive electrode current collector, or the positive electrode material layer provided only on one side of the positive electrode current collector. From the viewpoint of further increasing the capacity of the secondary battery, it is preferable that the positive electrode includes the positive electrode material layer on both sides of the positive electrode current collector.

The negative electrode is configured with at least a negative electrode material layer and a negative electrode current collector. In the negative electrode, a negative electrode material layer is provided on at least one side of the negative electrode current collector, and the negative electrode material layer contains a negative electrode active material as an electrode active material. For example, each of a plurality of the negative electrodes in the electrode assembly may include the negative electrode material layer provided on both sides of the negative electrode current collector, or the negative electrode material layer provided only on one side of the negative electrode current collector. From the viewpoint of further increasing the capacity of the secondary battery, it is preferable that the negative electrode includes the negative electrode material layer provided on both sides of the negative electrode current collector.

The electrode active materials contained in the positive electrode and the negative electrode, that is, the positive electrode active material and the negative electrode active material are substances directly involved in the transfer of electrons in the secondary battery, and are main substances of the positive and negative electrodes that are responsible for charging and discharging, that is, cell reaction. More specifically, ions are brought in an electrolyte due to “the positive electrode active material contained in the positive electrode material layer” and “the negative electrode active material contained in the negative electrode material layer”, and such ions move between the positive electrode and the negative electrode so that electrons are transferred, and charging and discharging are performed. The positive electrode material layer and the negative electrode material layer are preferably layers particularly capable of occluding and releasing lithium ions. That is, the secondary battery is preferably a non-aqueous electrolyte secondary battery, in which lithium ions move between a positive electrode and a negative electrode through a non-aqueous electrolyte to charge and discharge a battery. In a case where lithium ions are involved in charging and discharging, the secondary battery of the present invention corresponds to what is called a “lithium ion battery”, and the positive electrode and the negative electrode have layers capable of occluding and releasing lithium ions.

As the positive electrode active material of the positive electrode material layer is made of, for example, a granular body, it is preferable that a binder be included in the positive electrode material layer for particles to be in contact with each other more sufficiently and retaining a shape. Furthermore, a conductive auxiliary agent may be included in the positive electrode material layer in order to facilitate transmission of electrons promoting a cell reaction. Likewise, as the negative electrode active material of the negative electrode material layer is also made of, for example, a granular body, it is preferable that a binder be included for grains to be in contact with each other more sufficiently and retaining a shape, and a conductive auxiliary agent may be included in the negative electrode material layer in order to facilitate transmission of electrons promoting a cell reaction. As described above, since a plurality of components are contained, the positive electrode material layer and the negative electrode material layer can also be referred to as a “positive electrode mixture layer” and a “negative electrode mixture layer”, respectively.

The positive electrode active material is preferably a substance that contributes to occlusion and releasing of lithium ions. In this respect, it is preferable that the positive electrode active material be, for example, a lithium-containing composite oxide. More specifically, it is preferable that the positive electrode active material be a lithium transition metal composite oxide containing lithium and at least one kind of transition metal selected from a group consisting of cobalt, nickel, manganese, and iron. That is, in the positive electrode material layer of the secondary battery of the present invention, such a lithium transition metal composite oxide is preferably included as a positive electrode active material. For example, the positive electrode active material may be lithium cobalt oxide, lithium nickel oxide, lithium manganate, lithium iron phosphate, or part of their transition metals replaced with another metal. Although one kind of such a positive electrode active material may be included, two or more kinds of such a positive electrode active material may also be contained in combination. Although it is merely an example, in the secondary battery of the present invention, the positive electrode active material contained in the positive electrode material layer may be lithium cobalt oxide.

The binder which may be contained in the positive electrode material layer is not particularly limited, and can be at least one kind selected from a group consisting of polyvinylidene fluoride, vinylidene fluoride-hexafluoropropylene copolymer, vinylidene fluoride-tetrafluoroethylene copolymer, and polytetrafluoroethylene. The conductive auxiliary agent which may be contained in the positive electrode material layer is not particularly limited, and can be at least one kind selected from carbon black, such as thermal black, furnace black, channel black, ketjen black, acetylene black, and the like, graphite, a carbon fiber, such as carbon nanotube and vapor phase growth carbon fiber, metal powder of copper, nickel, aluminum, silver, and the like, polyphenylene derivative, and the like. For example, the binder of the positive electrode material layer may be polyvinylidene fluoride, and the conductive auxiliary agent of the positive electrode material layer may be carbon black. Although it is merely an example, the binder of the positive electrode material layer and the conductive auxiliary agent may be a combination of polyvinylidene fluoride and carbon black.

The negative electrode active material is preferably a substance that contributes to occlusion and releasing of lithium ions. In this respect, it is preferable that the negative electrode active material be, for example, various carbon materials, oxides or lithium alloys.

As the various carbon materials of the negative electrode active material, graphite (natural graphite, artificial graphite), hard carbon, soft carbon, diamond-like carbon, and the like can be mentioned. In particular, graphite is preferable because it has high electron conductivity and excellent adhesion to a negative electrode current collector. As the oxide of the negative electrode active material, at least one kind selected from a group consisting of silicon oxide, tin oxide, indium oxide, zinc oxide, lithium oxide, and the like can be mentioned. The lithium alloy of the negative electrode active material may be any metal which may be alloyed with lithium, and is preferably, for example, a binary, ternary or higher alloy of a metal, such as Al, Si, Pb, Sn, In, Bi, Ag, Ba, Ca, Hg, Pd, Pt, Te, Zn, La, and the like, and lithium. It is preferable that such an oxide be amorphous as its structural form. This is because degradation due to nonuniformity, such as crystal grain boundaries or defects, is hardly generated. Although it is merely an example, in the secondary battery of the present invention, the negative electrode active material of the negative electrode material layer may be artificial graphite.

The binder which may be contained in the negative electrode material layer is not particularly limited, and can be at least one kind selected from a group consisting of styrene butadiene rubber, polyacrylic acid, polyvinylidene fluoride, polyimide resin, and polyamide imide resin. For example, the binder contained in the negative electrode material layer may be styrene butadiene rubber. The conductive auxiliary agent which may be contained in the negative electrode material layer is not particularly limited, and can be at least one kind selected from carbon black, such as thermal black, furnace black, channel black, ketjen black, acetylene black, and the like, graphite, a carbon fiber, such as carbon nanotube and vapor phase growth carbon fiber, metal powder of copper, nickel, aluminum, silver, and the like, polyphenylene derivative, and the like. Note that the negative electrode material layer may contain a component derived from a thickener component (for example, carboxymethyl cellulose) used at the time of manufacturing a battery.

Although it is merely an example, the negative electrode active material and the binder in the negative electrode material layer may be a combination of artificial graphite and styrene butadiene rubber.

The positive electrode current collector and the negative electrode current collector used for the positive electrode and the negative electrode are members that contribute to collecting and supplying electrons generated in the active material due to a cell reaction. Such a current collector may be a sheet-like metal member and may have a porous or perforated form. For example, the current collector may be a metal foil, a punching metal, a net, an expanded metal, or the like. The positive electrode current collector used for the positive electrode is preferably made from a metal foil containing at least one selected from a group consisting of aluminum, stainless steel, nickel, and the like, and may be, for example, an aluminum foil. On the other hand, the negative electrode current collector used for the negative electrode is preferably made from a metal foil containing at least one selected from a group consisting of copper, stainless steel, nickel, and the like, and may be, for example, a copper foil.

The separator used for the positive electrode and the negative electrode is a member provided from the viewpoints of prevention of short circuit due to contact of the positive and negative electrodes, holding of the electrolyte, and the like. In other words, the separator can be considered as a member that allows ions to pass through while preventing electronic contact between the positive electrode and the negative electrode. Preferably, the separator is a porous or microporous insulating member and has a film form due to its small thickness. Although it is merely an example, a microporous film made from polyolefin may be used as the separator. In this regard, the microporous film used as the separator may contain, for example, only polyethylene (PE) or polypropylene (PP) as polyolefin. Furthermore, the separator may be a laminate body configured with a “microporous film made from PE” and a “microporous film made from PP”. A surface of the separator may be covered with an inorganic particle coat layer, an adhesive layer, or the like. The surface of the separator may have adhesive properties. Note that, in the present invention, the separator should not be particularly restricted by its name, and may be a solid electrolyte, a gel electrolyte, an insulating inorganic particle, or the like having a similar function.

In the secondary battery of the present invention, an electrode assembly configured with the electrode constituent layer including the positive electrode, the negative electrode, and the separator is enclosed in an exterior together with an electrolyte. When the positive electrode and the negative electrode have a layer capable of occluding and releasing lithium ions, the electrolyte is preferably a “non-aqueous” electrolyte, such as an organic electrolyte and an organic solvent (that is, the electrolyte is preferably a non-aqueous electrolyte). In the electrolyte, metal ions released from the electrode (the positive electrode or the negative electrode) exist, and hence the electrolyte helps transfer of metal ions in the cell reaction.

The non-aqueous electrolyte is an electrolyte containing a solvent and a solute. A specific solvent of the non-aqueous electrolyte preferably include at least a carbonate. Such a carbonate may be cyclic carbonates and/or chain carbonates. Although not particularly limited, as the cyclic carbonates, at least one selected from a group consisting of propylene carbonate (PC), ethylene carbonate (EC), butylene carbonate (BC), and vinylene carbonate (VC) can be mentioned. As the chain carbonates, at least one selected from the group consisting of dimethyl carbonate (DMC), diethyl carbonate (DEC), ethyl methyl carbonate (EMC) and dipropyl carbonate (DPC) can be mentioned. Although it is merely an example, a combination of cyclic carbonates and chain carbonates may be used as the non-aqueous electrolyte, and, for example, a mixture of ethylene carbonate and diethyl carbonate is used. As a specific solute of the non-aqueous electrolyte, for example, a Li salt, such as LiPF6 and/or LiBF4, is preferably used.

The exterior body of the secondary battery encloses the electrode assembly in which the electrode constituent layers including the positive electrode, the negative electrode, and the separator are laminated, and may have a form of a hard case, or may have a form of a soft case. Specifically, the exterior body may be a hard case type corresponding to what is called a “metal can”, or may be a soft case type corresponding to a “pouch” made from what is called a laminate film.

(Basic Battery Manufacturing)

A basic battery manufacturing method according to the secondary battery of the present invention will be described. In the manufacturing method of the secondary battery, the positive electrode, the negative electrode, an electrolytic solution and the separator (which may be procured from commercially available products as needed) are fabricated and prepared, and then integrated and combined, so that the secondary battery can be obtained.

In the fabrication of the positive electrode, first, a positive electrode material slurry is prepared. The positive electrode material slurry is an electrode material layer raw material containing at least a positive electrode active material and a binder. The positive electrode material slurry is applied to a metal sheet material (for example, aluminum foil) used as the positive electrode current collector, and rolled by a roll press machine. In this manner, a positive electrode precursor, that is, an electrode precursor is obtained. In particular, the metal sheet material preferably has a long belt-like shape, and the positive electrode material slurry is applied to such a long metal sheet. The area to be applied with the positive electrode material slurry is not the entire area of the long metal sheet, and the positive electrode material slurry is preferably not applied to a peripheral portion in both width directions of the metal sheet material (more specifically, end portions in a direction orthogonal to a direction in which cutting is sequentially performed), or the like. In one preferred mode, it is preferable to apply the positive electrode material slurry in a similar long shape so as to be smaller than the long metal sheet material. The resultant positive electrode precursor (particularly, a long positive electrode precursor in a belt shape) is wound in a roll shape or the like to be stored as needed, or subjected to transportation or the like as appropriate, until it is subjected to the next step. Then, in the next step, cutting is performed to obtain a plurality of positive electrodes from the positive electrode precursor (when wound in a roll shape, the positive electrode precursor is developed and cut). For example, the positive electrode is cut out from the positive electrode precursor (in particular, “the portion applied with the positive electrode material slurry”) by subjecting the positive electrode precursor to mechanical cutting. Although it is merely an example, what is called “punching operation” may be performed. Through the above operation, it is possible to obtain a plurality of desired positive electrodes.

The preparation of the negative electrode is similar to the preparation of the positive electrode. In the preparation of the negative electrode, first, a negative electrode material slurry is prepared. The negative electrode material slurry is an electrode material layer raw material containing at least a negative electrode active material and a binder. The negative electrode material slurry is applied to a metal sheet material (for example, copper foil) used as the negative electrode current collector, and rolled by a roll press machine. In this manner, a negative electrode precursor, that is, an electrode precursor is obtained. In particular, the metal sheet material preferably has a long belt-like shape, and the negative electrode material slurry is applied to such a long metal sheet material. The area to be applied with the negative electrode material slurry is not the entire area of the long metal sheet material, and the negative electrode material slurry is preferably not applied to a peripheral portion in both width directions of the metal sheet material (more specifically, end portions in a direction orthogonal to a direction in which cutting is sequentially performed), or the like. In one preferred embodiment, it is preferable to apply the negative electrode material slurry in a similar long shape so as to be smaller than the long metal sheet material. The resultant negative electrode precursor (particularly, a long negative electrode precursor in a belt shape) is wound in a roll shape or the like to be stored as needed, or subjected to transportation or the like as appropriate, until it is subjected to the next step. Then, in the next step, cutting is performed to obtain a plurality of negative electrodes from the negative electrode precursor (when wound in a roll shape, the positive electrode precursor is developed and cut). For example, the negative electrode is cut out from the negative electrode precursor (in particular, “the portion applied with the negative electrode material slurry”) by subjecting the negative electrode precursor to mechanical cutting. Although it is merely an example, what is called “punching operation” may be performed. Through the above operation, it is possible to obtain a plurality of desired negative electrodes.

An electrolyte that will be responsible for ionic migration between the positive electrode and the negative electrode when the battery is used is prepared. In a case of a lithium ion battery, in particular, a non-aqueous electrolyte is prepared. Therefore, raw materials to be an electrolyte are mixed to prepare a desired electrolyte. Note that the electrolyte may be a conventional electrolyte used in a conventional secondary battery, and hence the raw material of the electrolyte may also be those conventionally used in the production of secondary batteries.

The separator interposed between the positive electrode and the negative electrode may be a conventional one, and therefore, a separator conventionally used for a secondary battery may be used.

The secondary battery can be obtained by integrally combining the positive electrode, the negative electrode, the electrolyte solution, and the separator fabricated and prepared as described above. In particular, a plurality of the positive electrodes and a plurality of the negative electrodes are laminated with the separator interposed between them to form an electrode assembly, and the electrode assembly is enclosed in an exterior body together with an electrolyte, so that the secondary battery can be obtained. Note that the separator to be laminated may be one that is cut into a sheet, or may be laminated in a meandering shape and an excess portion is cut off. Furthermore, an electrode individually packaged with the separator may be laminated.

[Feature of the Secondary Battery of the Present Invention]

The secondary battery of the present invention has a feature in the uneven outer shape design. In particular, the present invention has a feature in which the positional design of an uneven step is suitably achieved by the electrode assembly and the secondary battery obtained by enclosing the electrode assembly with the exterior body. In other words, designing of a step position is suitably performed between the electrode assembly in which the electrode constituent layers including the positive electrode, the negative electrode, and the separator between them are layered and the secondary battery having the exterior body enclosing the electrode assembly.

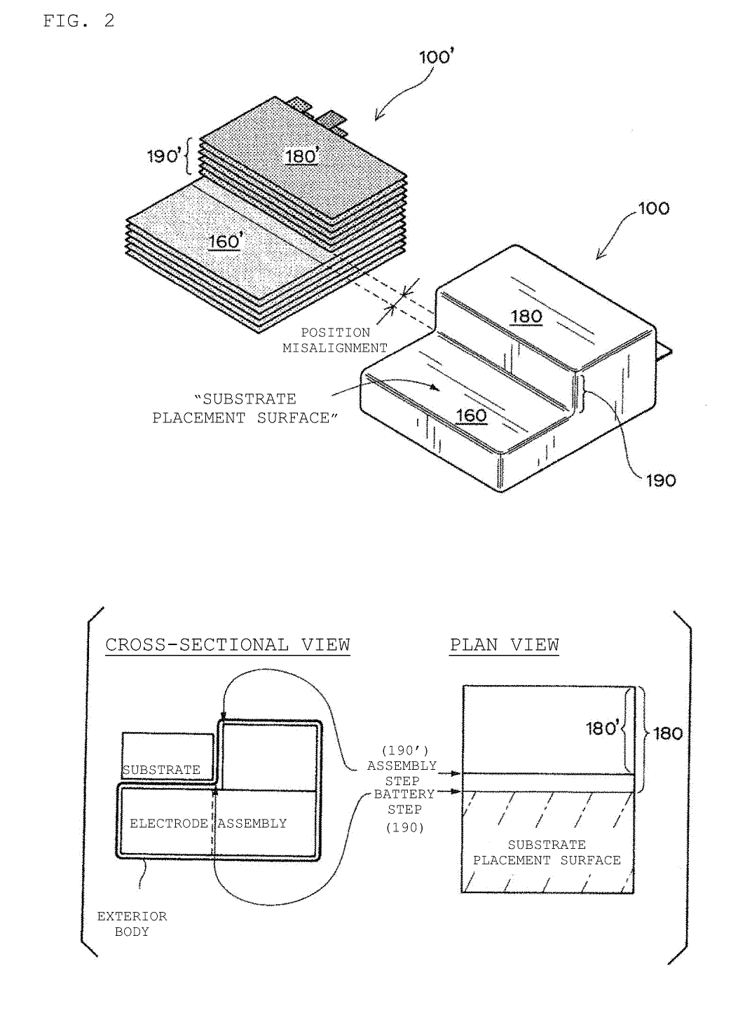

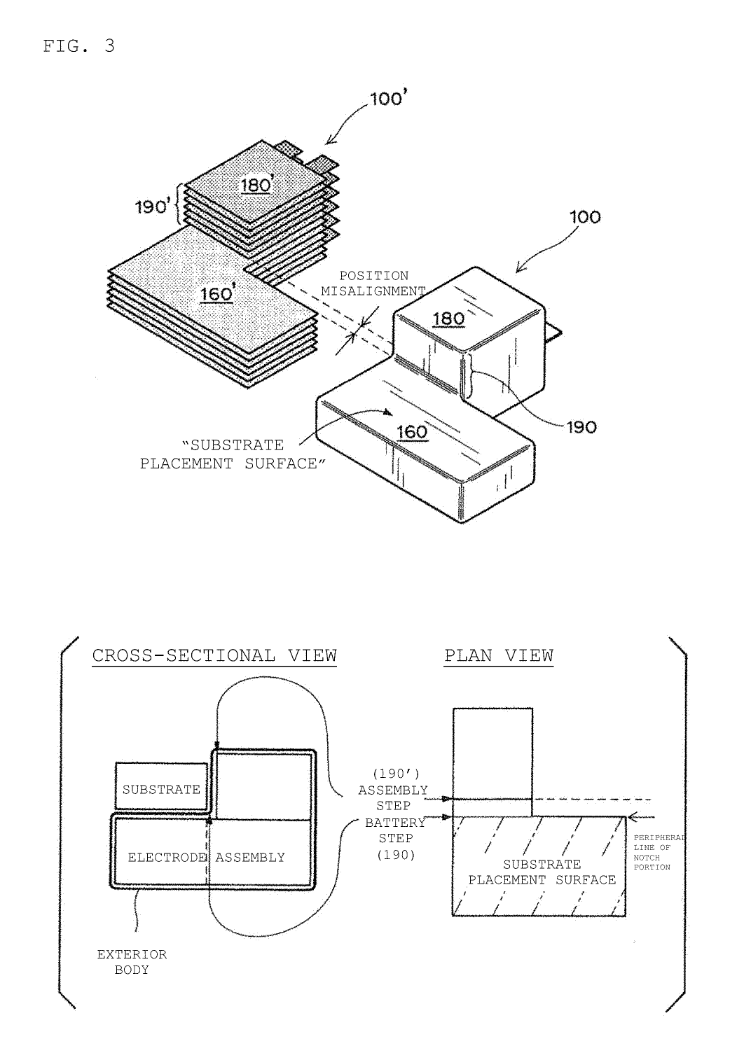

As shown in FIGS. 2 and 3, in a secondary battery 100 of the present invention, the electrode assembly 100′ that has an assembly step 190′ formed of an assembly low surface 160′ at a relatively low level and an assembly high surface 180′ at a relatively high level, and the secondary battery 100 has a battery step 190 formed of a battery low surface 160 at a relatively low level and a battery high surface 180 at a relatively high level, and the battery low surface 160 is a substrate placement surface with a margin of a position misalignment between the assembly step 190′ and the battery step 190.

The term “level” used in connection with “step” refers to a height level of an object, such as the electrode assembly or the secondary battery, and, in particular, indicates a height level using one main surface of each of the electrode assembly and the secondary battery (in particular, a surface corresponding to a bottom surface or a lower surface) as a reference.

In the secondary battery of the present invention, “a low-level substrate placement surface that is relatively low used for installation in combination with a substrate” is in consideration of a deviation in installation positions between the assembly step 190′ and the battery step 190. In other words, in the present invention, a surface (the assembly low surface 160′) which may be usable as the substrate placement surface in the electrode assembly 100′ is designed to be more suitable as a final substrate placement surface of the secondary battery.

The term “substrate placement surface” as used in the present description means, in a broad sense, a surface on which a substrate can be placed in an outer surface of the battery, and in a narrow sense, a battery low surface that is obtained as a three-dimensional outer shape of the battery becomes relatively low (preferably locally low) due to a step, the battery low surface on which a substrate can be placed in such a manner that dead space between the battery and the substrate (for example, an electronic circuit board described later) installed in the housing together with the battery can be reduced. Therefore, according to the present invention, the secondary battery may also be provided as a battery assembly suitably used together with the substrate.

Here, in the secondary battery of the present invention, while a position misalignment between the assembly step and the battery step is a position misalignment on a plane orthogonal to a thickness direction of the electrode assembly and the secondary battery, the expression “with a margin of a position misalignment” means that the substrate placement surface is provided by including such a “position misalignment” as a margin or dead size in advance. That is, in the secondary battery of the present invention, the battery low surface used as the substrate placement surface is provided in consideration of not only a step position of the three-dimensional outer shape of the secondary battery but also a step position of the three-dimensional outer shape of the electrode assembly.

The inventor of the present application has found out that the exterior body of the secondary battery particularly has a significant influence on the substrate placement surface. As shown in FIGS. 2 and 3, while the electrode assembly 100′ is finally enclosed in the exterior body to form the secondary battery 100, a position misalignment may occur between the assembly step 190′ and the battery step 190 due to the exterior body. Such a “position misalignment” has not been particularly noticed by those skilled in the art in the first place, and has been noticed by the inventor of the present invention designing the battery low surface of the secondary battery resulting from a step as the substrate placement surface.

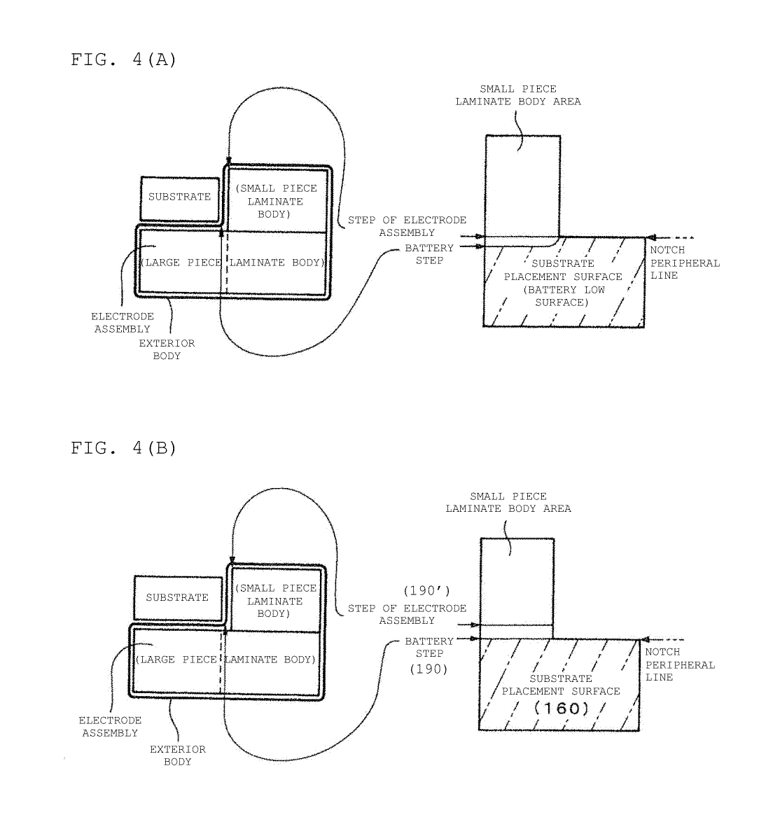

In particular, in the present invention, the battery low surface 160 is the substrate placement surface using a position misalignment between the assembly step 190′ and the battery step 190 as a margin, so that an effective area as the substrate placement surface is not excessively reduced. A mode in which the effective area as the substrate placement surface is excessively reduced will be described with reference to FIG. 4 as an example. FIG. 4(A) shows an example in which the battery low surface is designed without considering a position misalignment between the assembly step and the battery step as a margin. On the other hand, FIG. 4(B) shows an example in which the battery low surface 160 is suitably designed in consideration of a position misalignment between the assembly step 190′ and the battery step 190 as a margin. While, in FIG. 4(A), the surface that is usable as the substrate placement surface in the electrode assembly due to the “position misalignment” is excessively reduced due to the presence of the exterior body in a case of the secondary battery, in FIG. 4(B), the surface that is usable as the substrate placement surface in the electrode assembly due to the “position misalignment” is not excessively reduced due to the presence of the exterior body even in a case of the secondary battery. That is, as shown in FIG. 4(B), in the secondary battery in which the battery low surface 160 is suitably designed in consideration of a position misalignment between the assembly step 190′ and the battery step 190 as a margin, the battery low surface 160 as the substrate placement surface is not excessively restricted even if the exterior body exists, and the battery low surface 160 resulting from a step can be more widely provided as the substrate placement surface.

As can be understood with reference to FIGS. 3, 4(A), and 4(B), in “the secondary battery in which the battery low surface 160 is the substrate placement surface with a margin of a position misalignment between the assembly step 190′ and the battery step 190”, a surface shape of the battery low surface 160 in a plan view corresponds to a shape in which a position misalignment direction dimension of a surface shape of the assembly low surface 160′ is slightly reduced, and a surface shape of the battery low surface 160 is preferably rectangular. In other words, the substrate placement surface on which the substrate can be placed has a geometric shape (preferably a symmetrical geometric shape) such as a rectangular shape or a square shape.

In the secondary battery of the present invention, the position misalignment between the assembly step 190′ and the battery step 190 is particularly caused by the exterior body. More specifically, the “position misalignment” is caused by the exterior body enclosing the electrode assembly, and particularly caused by an “exterior body bent portion” located adjacent to the assembly step in the exterior body.

As shown in a cross-sectional view in parentheses in FIG. 2 and FIG. 3, although the “exterior body bent portion” extends along a contour shape of the assembly step, the exterior body may be slightly swollen at a step top portion and a step bottom portion, which may constitute the “position misalignment” with a thickness of the exterior body. Further, in the electrode assembly of a planar laminate structure in which the electrode constituent layers are laminated in a planar shape, there is a case where constituent elements, such as the separator, protrude from a side surface, which may also constitute the “position misalignment” together with the thickness of the exterior body. Therefore, in the secondary battery of the present invention, the battery low surface 160 is preferably provided as “the substrate placement surface using the position misalignment between the assembly step 190′ and the battery step 190 as a margin” in consideration of the “exterior body bent portion” and/or a “side protrusion of the assembly constituent”, and the like.

More specifically, in the secondary battery of the present invention, “the dimension (dimension of a position misalignment in the plan view) of a position misalignment between the assembly step 190′ and the battery step 190” is preferably 1.5 to 50 times, more preferably 1.5 to 30 times, and more preferably 1.5 to 20 times (for example, 1.5 times to 10 times) the thickness of the exterior body. As a result, the battery low surface 160 suitably including the position misalignment between the assembly step 190′ and the battery step 190 is provided as the substrate placement surface.

The exterior body used in the secondary battery of the present invention may be made from what is called a laminated film. That is, the exterior body may be a soft case type corresponding to a “pouch”. Alternatively, the exterior body used in the secondary battery of the present invention may be a hard case type corresponding to what is called a “metal can”. Typically, a thickness of the exterior body in the form of a soft case is smaller than a thickness of the exterior body in the form of a hard case. Accordingly, in view of the above, in the secondary battery of the present invention, “the dimension of the position misalignment between the assembly step 190′ and the battery step 190” in the case of the form of the soft case may be relatively small compared to the case of the form of the hard case, while the form of the hard case may be relatively larger than the form of the soft case.

With regard to the exterior body in the form of the soft case, the thickness dimension and/or the soft characteristic of the soft case can lead to reduction in “the dimension of the position misalignment between the assembly step 190′ and the battery step 190” in the secondary battery of the present invention. More specifically, the exterior body in the form of the soft case is preferably a flexible pouch (soft bag) composed of a soft sheet. The soft sheet is easy to bend, preferably a plastic sheet. Such a plastic sheet is a sheet which may maintain deformation due to an external force when the external force is removed after applied. For example, what is called a laminate film may be used for the flexible pouch. A flexible pouch made from a laminate film is obtained by, for example, laminating two laminate films and heating a peripheral portion of the laminate films. As the laminate film, a film in which a metal foil and a polymer film are laminated can be used. For example, a three-layer laminate film including an outer layer polymer film/a metal foil/an inner layer polymer film can be used. The outer layer polymer film may be formed of a polymer of polyamide, polyester, and the like, which contributes to prevention of damage of the metal foil due to permeation and contact of moisture and the like. The metal foil is for preventing permeation of moisture and gas, and is preferably foil made of copper, aluminum, stainless steel, or the like. Then, the inner layer polymer film may protect the metal foil from the electrolyte in the secondary battery, contribute to melt sealing at the time of heat sealing, and may be formed of polyolefin or acid modified polyolefin. The thickness of the exterior body in the form of the soft case may be within a range of 10 μm to 500 μm, for example, 40 μm to 100 μm. On the other hand, with regard to the exterior body in the form of the hard case, for example, one conventionally employed as a hard case exterior body of a conventional secondary battery may be used. The thickness of the exterior body in the form of the hard case may be, for example, within a range of 60 μm to 2 mm, and may be 80 μm to 800 μm, although this is merely one example.

A substrate that may be used together with the present invention, that is, a substrate that can be placed on the substrate placement surface, is preferably an electronic circuit board in particular. That is, the substrate that can be placed on the substrate placement surface may fall within the category of what is called a flexible substrate, or may fall within the category of what is called a rigid substrate. Further, from another point of view, such a substrate may be a printed circuit board, a protective circuit board, a semiconductor substrate, a glass substrate, or the like. In a preferred embodiment, the secondary battery of the present invention is used together with a protective circuit board to prevent overcharge, overdischarge and/or overcurrent of the battery, so the “substrate placement surface” is a surface for the protective circuit board. Preferably, a main surface shape (for example, a bottom surface shape) of such a substrate is substantially the same as the plan view shape of the substrate placement surface of the secondary battery, and, in a battery assembly configured with the secondary battery of the present invention and the substrate, the substrate can be provided without protruding from the secondary battery (without protruding in a direction orthogonal to the laminating direction).

The effect of the present invention is particularly easy to understand in a case of a secondary battery including a notch portion in a three-dimensional outer shape. This will be described in detail below.

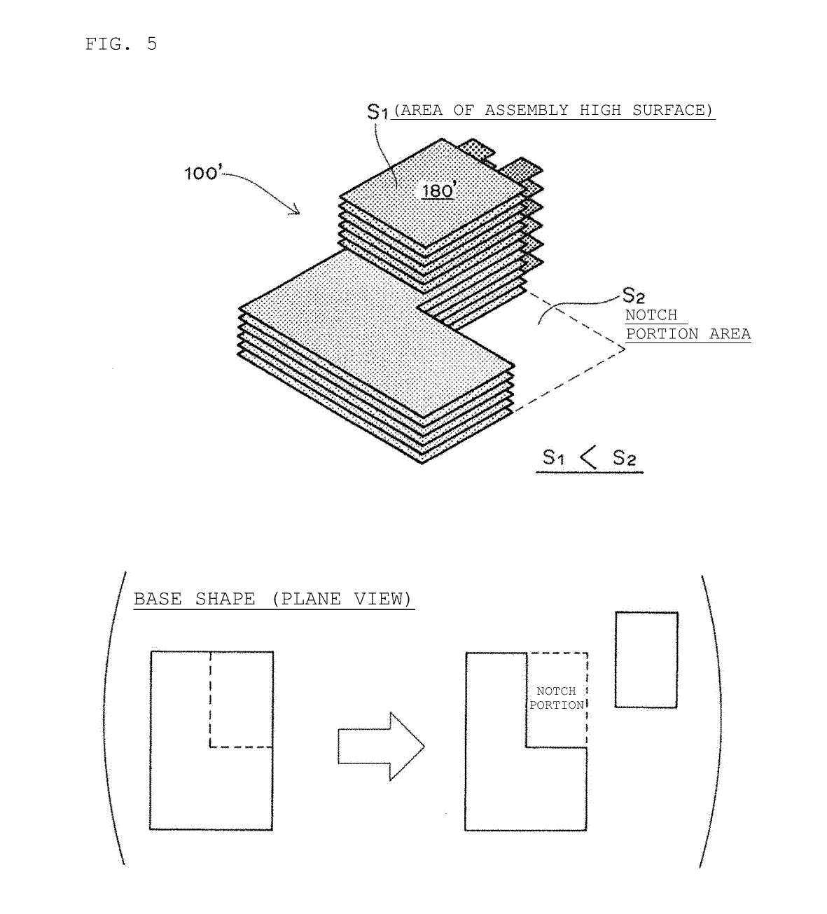

A typical appearance form of “a secondary battery including a notch portion in a three-dimensional outer shape” is shown in FIG. 3. As illustrated, the secondary battery 100 has a notch portion in its entire outer shape, and hence the electrode assembly 100′ likewise includes a notch portion. The expression “includes a notch” in used here means that, as shown in FIG. 5 (particularly in brackets on a lower side), a shape of the secondary battery/electrode assembly in the plan view is based on a certain shape, and has a portion being cut out. For example, as illustrated, the expression means that while the shape of the secondary battery/electrode assembly in the plan view is based on a square or rectangle, the shape is partially cut out (particularly, a corner portion of the square/rectangular used as the base is cut out).

In the case of the secondary battery of such a form (that is, in the “case where the notch portion is included in the entire outer shape of the secondary battery”), a difference between a peripheral line of the notch portion and the assembly step in the plan view preferably corresponds to the “position misalignment”. That is, as shown in brackets on a lower side in FIG. 3, the position misalignment between the assembly step 190′ and the battery step 190 in the plan view preferably corresponds to the difference between the peripheral line of the notch portion and the assembly step. As understood from FIGS. 3 and 5, the “peripheral line of the notch portion” means a contour line of a portion corresponding to the notch portion in a contour of the secondary battery/electrode assembly in the plan view (in particular, a contour line on a side substantially parallel to an extending direction of the step) or an imaginary line extending from the contour line.

If the difference between the peripheral line of the notch portion and the assembly step corresponds to the “position misalignment” in the plan view, the battery low surface as the substrate placement surface is not excessively restricted even if the exterior body finally exists, and the battery low surface resulting from the step can be widely used as the substrate placement surface. This can be understood well by comparing FIG. 4(A) and FIG. 4(B). FIG. 4(B) shows “a mode in which the difference between the peripheral line (notch peripheral line) of the notch portion and the assembly step in the plan view corresponds to the ‘position misalignment’”, and FIG. 4(A) shows a mode that is not under such a condition. In FIG. 4(A), a surface that can be widely used as the substrate placement surface in the electrode assembly is more limited due to the “position misalignment between the assembly step and the battery step”, whereas in FIG. 4(B), the surface that can be widely used as the substrate placement surface in such a manner is not limited by the “position misalignment between the assembly step and the battery step”. That is, there is no “position misalignment” in a wide area in the shape of the secondary battery/electrode assembly in the plan view, and therefore the surface (the surface of the wide area) widely usable as the substrate placement surface is not limited. As shown in FIG. 4(B), a contour portion in the plan view of the substrate placement surface is substantially all linear (more specifically, all sides constituting the contour are linear, for example, four sides constituting the contour are linear).

With respect to the typical mode shown in FIGS. 3 to 5, the shape of the notch portion is rectangular in the plan view, whereas the contour shape (contour shape in the plan view) of the electrode assembly or the secondary battery is preferably non-rectangular. The “rectangular shape” as used here means a shape, by which the cut-out shape (that is, a shape cut out from the base shape) in the plan view is normally included in a concept of a rectangular shape, such as a square shape and a rectangular shape. Therefore, the “rectangular shape” indicates that a virtual cut-out shape in the plan view as seen from an upper side in a thickness direction corresponds to a substantially square shape or a substantially rectangular shape. On the other hand, the “non-rectangular shape” as used here refers to a shape which is not normally included in a concept of a rectangular shape, such as a square shape and a rectangular shape in the plan view, and, in particular, indicates a shape obtained by cutting out part of a square or rectangular shape. Accordingly, in a broad sense, the “non-rectangular shape” refers to a shape in the plan view seen from the upper side in the thickness direction, which is not square or rectangular, and in a narrow sense, a shape in the plan view is based on a square or rectangle which is partially cut out (preferably a shape in which a corner portion of the square or rectangle used as the base is notched) (see FIG. 5). By way of example, the “non-rectangular shape” may be a shape of the contour shape of the electrode assembly or the secondary battery in the plan view based on a square or rectangular shape, the shape obtained by cutting out a shape of part or a combination of a square, a rectangle, a semicircle, a semi-ellipse, or a circle and ellipse shape from the base shape (in particular, a shape obtained by cutting out such a shape from the corner portion of the base shape).

As described above, the shape of the notch portion in the plan view is rectangular and the contour shape of the electrode assembly or the secondary battery in the plan view is non-rectangular, which may contribute to use of the battery low surface resulting from the step more widely as the substrate placement surface as can be seen from the mode shown in FIGS. 3 to 5.

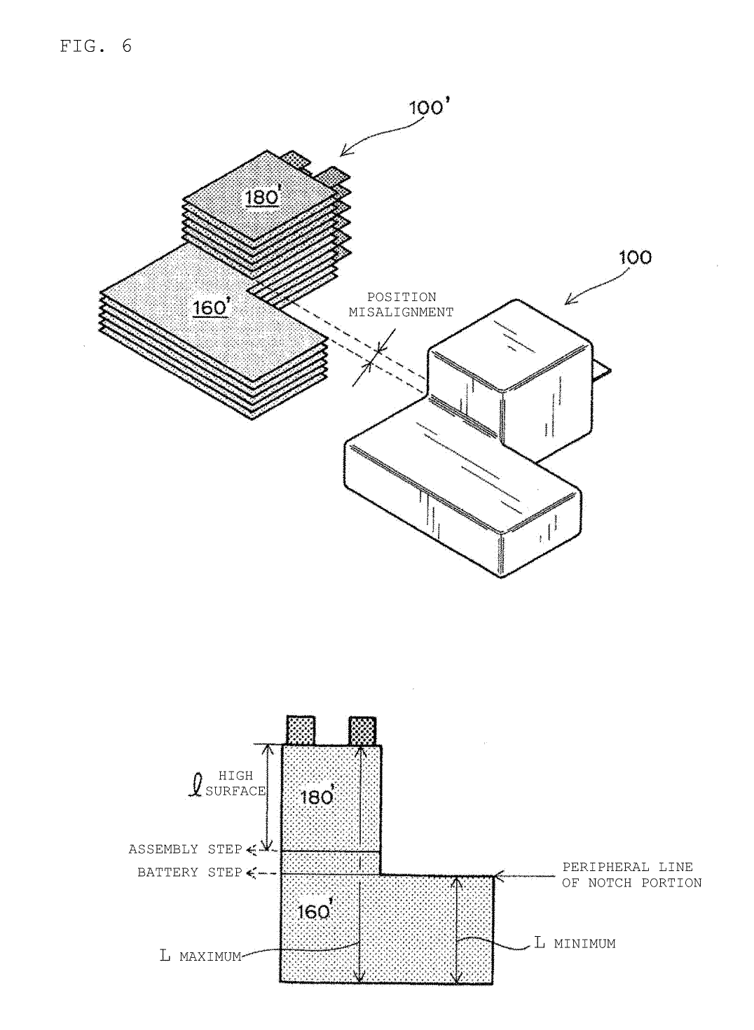

In the electrode assembly and the secondary battery shown in FIGS. 3, 4(B) and 5, the battery low surface resulting from the step is more widely provided as the substrate placement surface as described above (that is, the battery low surface is the substrate placement surface with the margin of the position misalignment between the assembly step and the battery step), which results in characteristics of the electrode assembly and the secondary battery. For example, if a dimension in a direction in which the “position misalignment” occurs in the plan view is defined as a position misalignment direction dimension, the position misalignment direction dimension of the assembly high surface is smaller than a difference between a maximum position misalignment direction dimension and a minimum position misalignment direction dimension in the contour shape of the electrode assembly (see FIG. 6). More specifically, as shown on a lower side of FIG. 6, when “a difference between a maximum dimension Lₘₐₓᵢₘᵤₘ and a minimum dimension Lₘᵢₙᵢₘᵤₘ along a direction in which the ‘position misalignment’ occurs in the contour shape of the electrode assembly 100′ in the plan view” is compared with “a dimension l_{high surface} of the assembly high height surface 180′ along the direction in which the “position misalignment” occurs in a similar manner”, the latter one is smaller than the former one. That is, (Lₘₐₓᵢₘᵤₘ−Lₘᵢₙᵢₘᵤₘ)>l_{high surface} is established. In other words, it can be said that the battery low surface resulting from the step can be provided more widely as the substrate placement surface because of such a dimensional relationship.

Further, in the electrode assembly and the secondary battery shown in FIGS. 3, 4(B), and 5, the area of the assembly high surface is smaller than the area of the notch portion in the plan view. More specifically, as shown in FIG. 5, S₁<S₂ is preferably established, where S₁ is an area in the plan view of the assembly high surface 180′ and S₂ is an area in the plan view of the notch portion. Such a feature may be related particularly to a manufacturing method of a secondary battery.

Hereinafter, a typical manufacturing method for obtaining the electrode assembly and the secondary battery shown in FIG. 3, FIG. 4(B), and FIG. 5 will be described in detail.

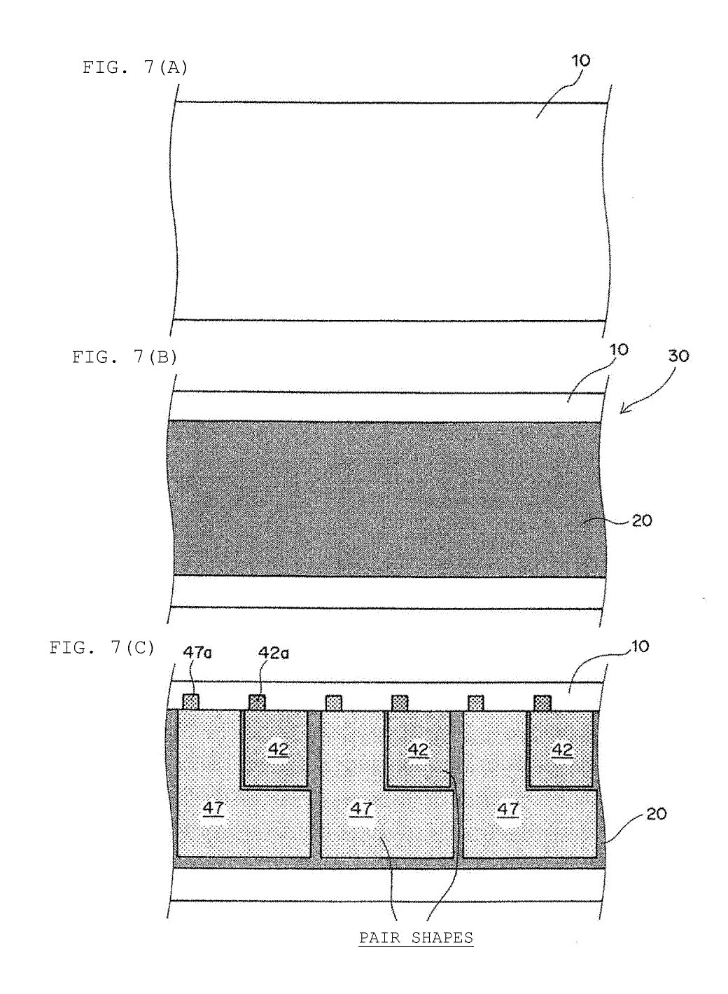

Such a manufacturing method is characterized by a manufacturing method of an electrode, and is particularly characterized by cutting out a plurality of electrodes at the time of manufacturing at least one of a positive electrode and a negative electrode. Specifically, as shown in FIG. 7, manufacturing of at least one of the positive electrode and the negative electrode includes obtaining an electrode precursor 30 by forming an electrode material layer 20 on a metal sheet material 10 serving as an electrode current collector, and forming an electrode by cutting out from the electrode precursor 30, and the plurality of cut-out shapes include pair shapes made up of a relatively small piece shape 42 and a relatively large piece shape 47.

The term “pair shapes” as used here means, in a broad sense, a combination of two adjacent shapes in the plan view, and in a narrow sense, a combination (pair) of a relatively small shape (“small piece shape”) and a relatively large shape (“large piece shape”) which are adjacent to each other in the plan view as seen from the upper side in the thickness direction. Therefore, among a plurality of cut-out shapes in the plan view as shown in FIG. 7, a combination of two shapes, large and small ones, that are positioned side by side correspond to “pair shapes”.

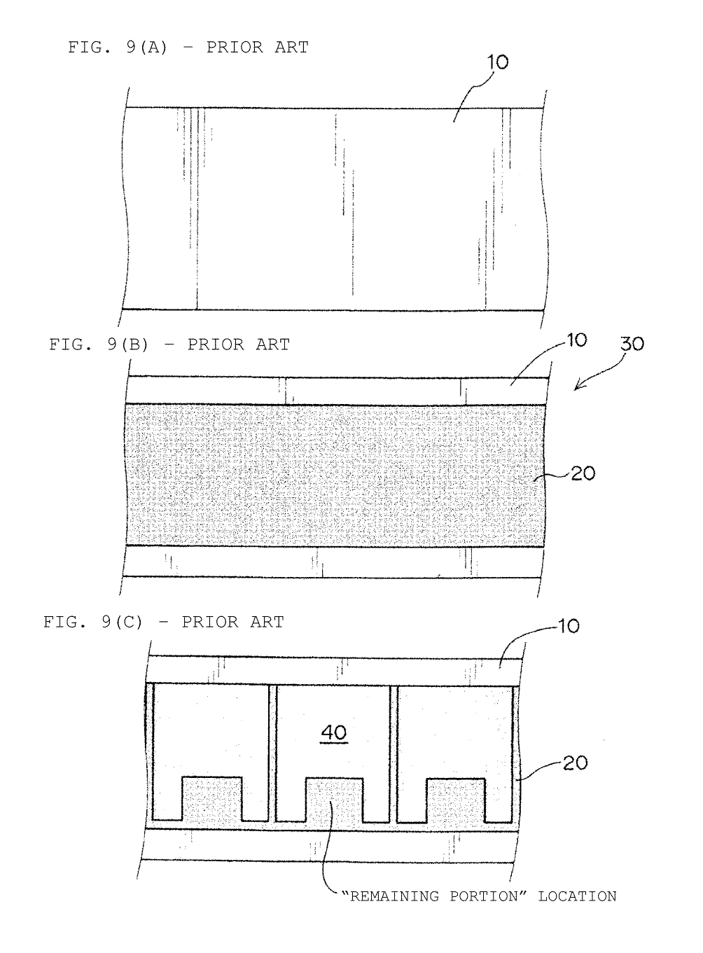

If a plurality of electrodes are cut out so as to include pair shapes made up of large and small shapes, a remaining portion after the cutout can be effectively reduced. This means that it is possible to reduce a “waste portion” which is not finally used in manufacturing of the secondary battery (in particular, it is possible to reduce a waste electrode active material which does not finally become a battery constituent), and manufacturing efficiency of the secondary battery becomes higher. Further, reduction in a “waste portion” leads to low cost manufacturing of the secondary battery (“high manufacturing efficiency”/“low cost manufacturing” is more understandable with reference to FIG. 9 showing a conventional process mode).

Particularly, with regard to the secondary battery of the present invention, a plurality of electrodes are cut out so as to include at least one of pair shapes including at least a “relatively small piece shape” and a “relatively large piece shape”. The “relatively large piece shape” as used here means a cut-out shape having a relatively large area among the pair shapes in the plan view. Likewise, the “relatively small piece shape” means a cut-out shape having a relatively small area among the pair shapes in the plan view. Although it is merely an example, an area of the small piece shape in the plan view may be ¾ or smaller, and may be, for example, a half or smaller.

As shown in FIG. 7, the “relatively small piece shape 42” and the “relatively large piece shape 47” making up pair shapes preferably have complementary shapes. That is, the small piece shape 42 and the large piece shape 47 have a planar shape in a manner complementing each other in the plan view. As can be seen by referring to FIG. 7, the expression “have complementary shapes” as used here means that portions facing each other in a contour of a small piece shape and a contour of a large piece shape in the plan view have substantially overlapping shapes. More specifically, the expression “substantially overlapping shapes” means that a contour portion of a small piece shape may be substantially included in a contour portion of a large piece shape in contour portions facing each other in the plan view.

In a case of manufacturing the positive electrode, the small piece shape 42 and the large piece shape 47 forming a pair with respect to a cut-out shape of a plurality of the positive electrodes are preferably cut out from a positive electrode precursor so as to be complementary to each other. Similarly, in a case of manufacturing the negative electrode, the small piece shape 42 and the large piece shape 47 forming a pair with respect to a cut-out shape of a plurality of the negative electrodes are preferably cut out from a negative electrode precursor so as to be complementary to each other. In both cases, a preferable mode is that the complementary relationship is continuous in a longitudinal direction of the electrode precursor 30 (that is, a longitudinal direction of the metal sheet material 10). When a plurality of electrodes are cut out while maintaining the complementary relationship in this way, it is possible to more effectively reduce a remaining portion after cutting out.

Particularly preferably, as shown in FIG. 7, the “relatively small piece shape 42” making up pair shapes is rectangular while the “relatively large piece shape 47” is non-rectangular. The “rectangular shape” as used here means a shape, by which a cut-out shape (that is, a shape cut out as an electrode from the electrode precursor) in the plan view is normally included in a concept of a rectangular shape, such as a square shape and a rectangular shape. Therefore, the “rectangular shape” refers to a substantially square shape or a substantially rectangular shape in a cut-out shape (electrode shape) in the plan view as seen from the upper side in the thickness direction. On the other hand, the “non-rectangular shape” as used here refers to a cut-out shape (that is, the shape cut out as an electrode from the electrode precursor) which is not normally included in a concept of a rectangular shape, such as a square shape and a rectangular shape in the plan view, and, in particular, indicates a shape obtained by cutting out part of a square or rectangular shape. Accordingly, in a broad sense, the “non-rectangular shape” refers to a cut-out shape (electrode shape) in the plan view seen from the upper side in the thickness direction, which is not square or rectangular, and in a narrow sense, an electrode shape in the plan view is based on a square or rectangle which is partially cut out (preferably a shape in which a corner portion of the square or rectangle used as the base is notched). By way of example, the “non-rectangular shape” may be an electrode shape in the plan view based on a square or rectangular shape, the shape obtained by cutting out at least one shape of part or a combination of a square, a rectangle, a semicircle, a semi-ellipse, or a circle and ellipse shape from the base shape (in particular, a shape obtained by cutting out such a shape from the corner portion of the base shape).

When a plurality of electrodes are cut out so as to have rectangular and non-rectangular relationships in this way, it is possible to more effectively reduce a remaining portion after cutting out.

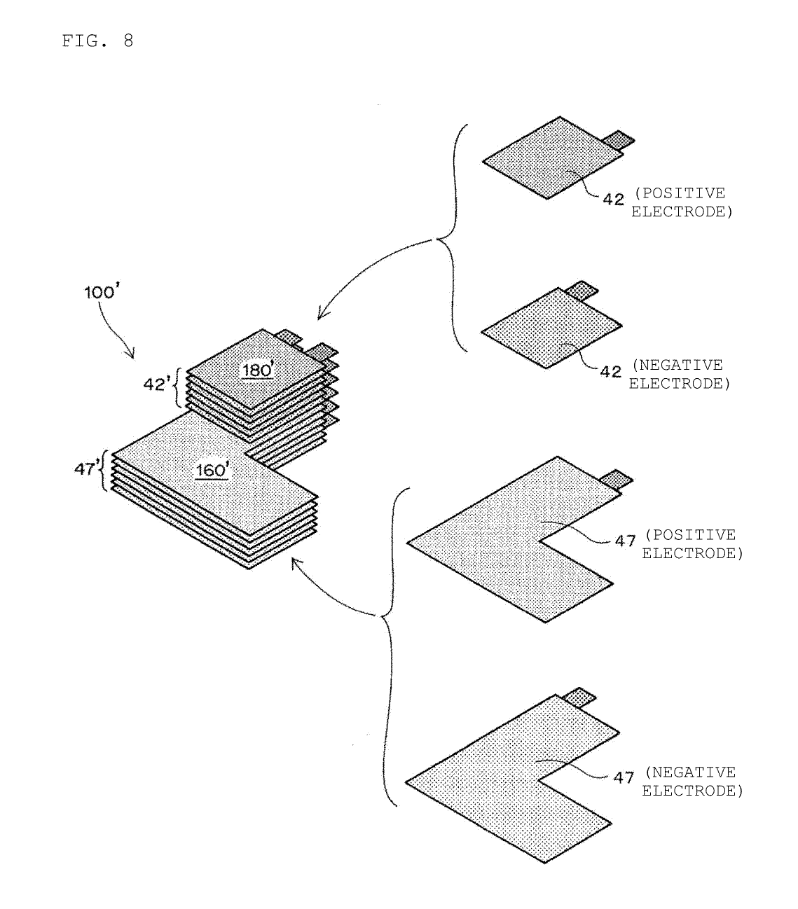

When the obtained small piece shape 42 and large piece shape 47 are used for manufacturing the same battery, it is possible to obtain the electrode assembly shown in FIG. 3, FIG. 4(B), and FIG. 5, and eventually the secondary battery can be obtained. Specifically, as shown in FIG. 8, when a small piece laminate body 42′ configured with the small piece shape 42 is positioned on a large piece laminate body 47′ configured with the large piece shape 47, the electrode assembly 100′ having an assembly step configured with the assembly low surface 160′ at a relatively low level and the assembly high surface 180′ at a relatively high level can be obtained, and then when the electrode assembly 100′ is sealed together with an electrolyte by the exterior body, the secondary battery including the battery step configured with the battery low surface at a relatively low level and the battery high surface at a relatively high level can be similarly obtained.

Based on the manufacturing method described above, in the electrode assembly and the secondary battery shown in FIG. 3, FIG. 4(B), and FIG. 5, an area of the assembly high surface is smaller than an area of the notch portion in the plan view. That is, the “area of the assembly high surface” corresponds to the area of the small piece shape 42 in the above manufacturing method, and the “notch portion” corresponds to an area in the electrode precursor 30 of FIG. 7 from which the small piece 42 is cut out. Therefore, the former (the area of the assembly high surface area) is smaller than the latter (the area of the notch portion).

Further, similarly based on the above-described manufacturing method, in the electrode assembly and the secondary battery shown in FIGS. 3, 4(B), and 5, a level difference between the bottom surface (that is, a lowermost surface) of the electrode assembly 100′ and the assembly low surface 160′ corresponds to a step dimension of the assembly step 190′. This results from configuration of the electrode assembly 100′ by using the small piece shape 42 and the large piece shape 47 forming a pair. That is, as shown in FIG. 8, as the electrode assembly 100′ is manufactured from the large piece laminate body 47′ configured with the large piece shape 47 and the small piece laminate body 42′ configured with the small piece shape 42, the numbers of the small piece shapes 42 and the large piece shapes 47 to be used can be the same or substantially the same due to “pairs”. This means that in the electrode assembly 100′ shown in FIG. 8, a thickness of the large piece laminate body 47′ and a thickness of the small piece laminate body 42′ may be substantially the same, and, therefore, a level difference between a bottom surface of the electrode assembly 100′ and the assembly low surface 160′ may correspond to a step dimension of the assembly step 190′. Note that the expression “a level difference corresponds to a step dimension” here means that, between the level difference and the step dimension”, one falls within a range of ±10% of the other. Note that, as for the exposed electrode which becomes the “substrate placement surface” of the large piece laminate body 47′, what is called a “double-sided positive electrode” (the positive electrode provided with a positive electrode material layer on both surfaces of the positive electrode current collector) is desirably not positioned.

Furthermore, similarly based on the above-described manufacturing method, the “dimension of a position misalignment” in the electrode assembly and the secondary battery shown in FIGS. 3, 4(B), and 5 may be 0.5 mm or larger and 5 mm or smaller. That is, although it is merely an example, in the secondary battery, the “dimension (position misalignment dimension in the plan view) of a position misalignment between the assembly step 190′ and the battery step 190 may be in the range of 0.5 mm or larger and 5 mm or smaller. This means that the present invention provides the secondary battery, in which the battery low surface 160 is suitably designed in consideration of a range of 0.5 mm or larger and 5 mm or smaller, which is a position misalignment dimension between the assembly step 190′ and the battery step 190, as a margin.

Although the embodiment of the present invention is described above, it merely exemplifies a typical example. Therefore, the present invention is not limited to the above, and those skilled in the art will readily understand that various modes can be conceived.

The secondary battery of the present invention can be used in various fields in which storage of electricity is expected. Although it is merely an example, the secondary battery can be used in the fields of electric, information and communications (for example, mobile equipment fields, such as mobile phones, smart phones, laptop computers, digital cameras, activity meters, arm computers, electronic papers, and the like) in which mobile equipment is used, home and small industrial applications (for example, electric tools, golf carts, domestic, nursing care, and industrial robot fields), large industrial applications (for example, forklifts, elevators, harbor port crane fields), transportation system fields (for example, fields of hybrid vehicles, electric vehicles, buses, trains, electric assisted bicycles, electric motorcycles, and the like), electric power system applications (for example, fields of various electric power generation, load conditioners, smart grids, general home electric storage systems, and the like), IoT fields, space and deep-sea applications (for example, fields of space explorers, research submarines, and the like), and the like.

### DESCRIPTION OF REFERENCE SYMBOLS

1: Positive electrode
2: Negative electrode
3: Separator
5: Electrode constituent layer
10: Metal sheet material
20: Electrode material layer
30: Electrode precursor
42: Small piece shape
42′: Small piece laminate body
47: Large piece shape
47′: Large piece laminate body
100: Secondary battery
160: Battery low surface
180: Battery high surface
190: Battery step
100′: Electrode assembly
160′: Assembly low surface
180′: Assembly high surface
190′: Assembly step

1. A secondary battery, comprising:
an electrode assembly having a plurality of laminated electrode constituent layers, each of the electrode constituent layers including a positive electrode, a negative electrode, and a separator between the positive electrode and the negative electrode; and
an exterior body enclosing the electrode assembly,
wherein
the electrode assembly has an assembly step connecting an assembly low surface and an assembly high surface at a higher level than the assembly low surface,
the exterior body has a battery low surface and a battery high surface at a higher level than the battery low surface, and
there is a margin of a position misalignment between the assembly step and the battery step.

2. The secondary battery according to claim 1, wherein the position misalignment is 1.5 to 50 times a thickness of the exterior body.

3. The secondary battery according to claim 1, wherein the position misalignment is 1.5 to 30 times a thickness of the exterior body.

4. The secondary battery according to claim 1, wherein the position misalignment is 1.5 to 20 times a thickness of the exterior body.

5. The secondary battery according to claim 2, wherein an entire outer shape of the secondary battery further defines a notch portion, and a difference between a peripheral line of the notch portion and the assembly step in a plan view corresponds to the position misalignment.

6. The secondary battery according to claim 5, wherein a shape of the notch portion is rectangular in the plan view, and a contour shape of the electrode assembly or the secondary battery is non-rectangular.

7. The secondary battery according to claim 5, wherein an area of the assembly high surface is smaller than an area of the notch portion in the plan view.

8. The secondary battery according to claim 5, wherein, when a dimension in a direction in which the position misalignment occurs in the plan view is defined as a position misalignment direction dimension, a position misalignment direction dimension of the assembly high surface is smaller than a difference between a maximum position misalignment direction dimension and a minimum position misalignment direction dimension in a contour shape of the electrode assembly.

9. The secondary battery according to claim 1, wherein an entire outer shape of the secondary battery further defines a notch portion, and a difference between a peripheral line of the notch portion and the assembly step in a plan view corresponds to the position misalignment.

10. The secondary battery according to claim 9, wherein a shape of the notch portion is rectangular in the plan view, and a contour shape of the electrode assembly or the secondary battery is non-rectangular.

11. The secondary battery according to claim 9, wherein an area of the assembly high surface is smaller than an area of the notch portion in the plan view.

12. The secondary battery according to claim 9, wherein, when a dimension in a direction in which the position misalignment occurs in the plan view is defined as a position misalignment direction dimension, a position misalignment direction dimension of the assembly high surface is smaller than a difference between a maximum position misalignment direction dimension and a minimum position misalignment direction dimension in a contour shape of the electrode assembly.

13. The secondary battery according to claim 1, wherein a level difference between a bottom surface of the electrode assembly and the assembly low surface corresponds to a step dimension of the assembly step.

14. The secondary battery according to claim 1, wherein the position misalignment is 0.5 mm to 5 mm.

15. The secondary battery according to claim 1, further comprising a substrate disposed on the battery low surface.

16. The secondary battery according to claim 15, wherein the substrate is a rigid substrate or a flexible substrate.

17. The secondary battery according to claim 15, wherein the substrate is a protective circuit board.

18. The secondary battery according to claim 1, wherein the electrode assembly has a planar lamination structure in which the positive electrode, the negative electrode, and the separator are laminated in a plane.

19. The secondary battery according to claim 1, wherein the electrode assembly has a wound laminate structure in which the positive electrode, the negative electrode, and the separator are wound.

20. The secondary battery according to claim 1, wherein the positive electrode and the negative electrode have a layer capable of occluding and releasing a lithium ion.
